(19) United States
(12) Patent Application Publication
(10) Pub. No.: US 2004/0008187 A1
(43) Pub. Date: Jan. 15, 2004

(54) Method for transmitting a high-frequency binary data stream via an electrically isolated communications path

(76) Inventors: Susanne Gaksch, Erlangen (DE); Kurt Gopfrich, Erlangen (DE)

Correspondence Address: HENRY M FEIEREISEN, LLC, 350 FIFTH AVENUE, SUITE 4714, NEW YORK, NY, 10118, US

(21) Appl. No.: 10/398,088

(22) PCT Filed: Sep. 17, 2001
(86) PCT No.: PCT/DE01/03577

(30) Foreign Application Priority Data
Sep. 29, 2000 (DE) 100 48 352.6

(51) Int. Cl. G09G 5/00

(52) U.S. Cl. 345/173

(57) ABSTRACT

The invention relates to a method for preparing a data stream and for transmitting it via transmitters. In order to permit use of a transmitter, the data stream is first subjected to non-zero frequency encoding, for example by Manchester encoding. For a synchronous transmission (FIG) two data streams have to be transmitted, but not in a bi-directional manner. The data signal is initially not average-free. To make transmission with a transmitter all the same possible, the signal is first for example EXOR-linked with the clock signal. The two signals are then both transmitted (the clock signal is EXOR-linked with 0 to avoid different run times) and the original data stream is recovered by again EXOR-linking the two signals.

The invention relates to a method for transmitting a high frequency binary data stream via an, in particular bidirectional, DC-isolated communication path, in particular a communication path with safe electrical isolation, as well as a method based thereon for synchronous transmission of a high frequency data stream.

In order to transmit a high frequency data stream via a DC-isolated path, the following properties of the data stream and the DC-isolation are frequently of particular importance for today's technical applications:

the DC-isolation should satisfy the requirements for safe isolation according to the standard EN 50178

required is immunity against interference for large changes in the voltage over time (du/dt), for example for applications in a frequency converter

the data transmission rate should be approximately 10 . . . 24 Mbaud, with the possibility for even higher data rates.

FIG. 2 shows a schematic diagram for data transmission with DC-isolation GT.

Frequently, long transmission lines (for example, of up to 100 meters) are used between the transmitter and receiver of the data stream, e.g., for communication between two devices, so that double DC-isolation is required, once proximate to the transmitter and then again proximate to the receiver. This situation is illustrated in FIG. 3, wherein for data transmission with long transmission lines a double DC-isolation GT is required.

Frequently, bidirectional transmission should be enabled via a single channel (but not simultaneously in both directions).

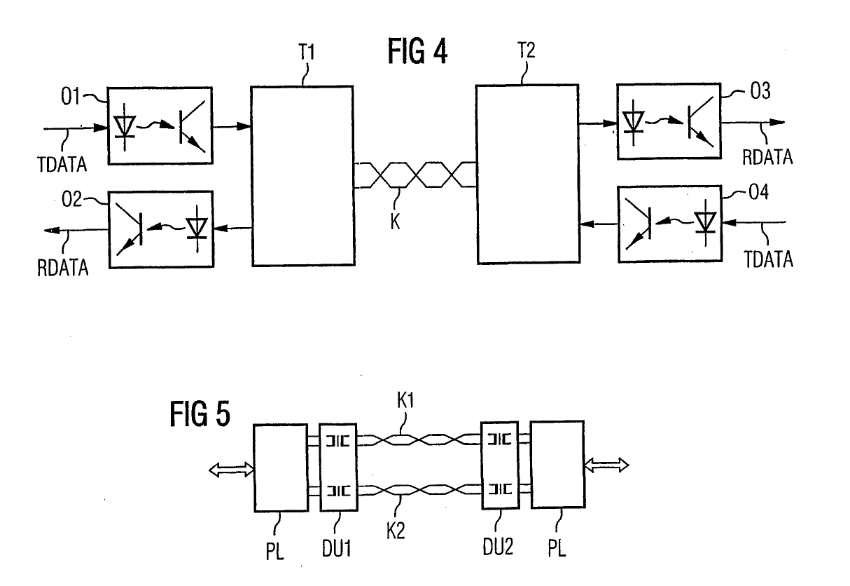

Conventionally, this problem is solved by using opto-couplers. Data transmission of this type with DC-isolation according to the state-of-the-art is shown in the diagram of FIG. 4.

Transceivers T1 and T2 driven by corresponding opto-couplers O1 to O4 are provided on both sides of a communication path K. The transceiver T1 receives, for example, incoming data TDATA via the opto-coupler O1, whereas received data RDATA are transmitted to an additional opto-coupler O2. The same applies to the other side of the communication path K having the transceiver T2 and the opto-couplers O3 and O4.

A serial data transmission based on this transmission structure is implemented, for example, in PROFIBUS.

This conventional arrangement with opto-couplers for DC-isolation, however, has several disadvantages. For example, for double DC-isolation, the intermediate section between the opto-couplers O1 to O4 must also be supplied with electric power (for supplying the two transceivers T1 and T2), which adds cost and complexity.

Moreover, opto-couplers have only a limited dielectric strength for a safe isolation and are also available only for limited data rates (today's data rates are at approximately 12 Mbaud).

Another conventional transmission technique attempts to solve this problem with optical waveguides. This is also disadvantageous, since the intermediate section of the communication path that generates the light pulses must have a dedicated power supply, which again adds cost and complexity. In addition, optical waveguides, like opto-couplers, are only available for limited data rates. A solution with optical waveguides is quite expensive due to the high cost of the optical waveguides.

Another solution has been proposed which employs components know from interoffice communication technology operating according to the ubiquitous Ethernet standard.

The diagram in FIG. 5 shows serial data transmission via Ethernet, whereby the conventional physical-layer components PL are provided on both sides of the transmission path. The actual transmission proceeds via the transmitters DU1 and DU2 on both sides of the communication path K1, K2.

Ethernet does not support bidirectional transmission via a single channel so that two separate channels K1 and K2 are required, which is more complex. As another disadvantage, the transmitters for Ethernet connections are not sufficiently immune from interference caused by large temporal voltage changes (du/dt), and hence do not provide safe isolation for voltages above approximately 300 V.

It is the object of the present invention to transmit a high frequency data stream via a DC-isolated transmission path in the simplest and least expensive manner.

According to the present invention, the object is solved by a method for transmitting a high frequency binary data stream via an, in particular bidirectional, DC-isolated communication path, with the following method steps:

encoding the data stream without a DC component on the transmitter side by generating artificial signal changes through

transmission of binary values of the data stream as a specified sequence of signal changes via a communication path with at least one electrical transmitter and

recovery of the original binary values of the data stream by associating the corresponding binary values with the sequences of signal changes received at the receiver side.

Since a transmitter cannot transmit DC voltages/currents and therefore also cannot transmit DC components of a data stream, but rather only AC voltages/currents, a DC component may potentially be applied to the transmitter that represents a sequence of identical binary values of the data stream over a longer period of time. According to the invention, the signal is therefore encoded without a DC component by introducing artificial jumps in the binary values to be transmitted which ensure that no DC components are produced.

It is particularly advantageous if

to each binary value ‘Zero’ there is assigned the binary signal string ‘Zero’ followed by a ‘One’, and

to each binary value ‘One’ there is assigned the binary signal string ‘One’ followed by a Zero’.

Alternatively, the same outcome can be achieved if

to each binary value ‘One’ there is assigned the binary signal string ‘Zero’ followed by a ‘One’, and

to each binary value ‘Zero’ there is assigned the binary signal string ‘One’ followed by a Zero’.

In other applications, such encoding is referred to as Manchester encoding.

The invention can be employed with little complexity by using a serial communication path for transmission.

According to another advantageous embodiment of the method of the invention, a transmission can take place in half duplex mode, wherein a characteristic value, in particular a start bit for identifying a message, is assigned to the start of each data stream on the transmitter side.

A corresponding characteristic value, in particular a start bit, can be used on the receiver side at the start of the recovery of the data encoded without a DC component.

According to another particularly advantageous embodiment of the invention, the object can also be solved by a method for synchronous transmission of a high frequency binary data stream with a data signal and a clock signal via an, in particular bidirectional, DC-isolated communication path, with the following method steps:

encoding the data signal by applying a Logical operator to a data signal and a clock signal on the transmitter side so as to produce an encoded data signal without a DC component,

transmitting the encoded data signal via a first communication path with at least one electrical transmitter,

transmitting the clock signal via a second communication path with at least one electrical transmitter, and

decoding the encoded data signal on the receiver side by applying another Logical operator to the encoded data signal and the clock signal so as to recover the original data signal.

In order to avoid different propagation times of the data transmitted via the two communication paths, the following method step has proven to be advantageous:

encoding and decoding the clock signal by applying the same Logical operator to a constant binary value and transmitting the encoded clock signal.

It has proven to be particularly simple and effective to carry out the following logical operation:

encoding the data signal by an logical exclusive-or operation applied to the data signal and clock signal on the transmitter side,

decoding the encoded data signal on the receiver side by applying once more the logical exclusive-or operation to the encoded data signal and clock signal.

In order to avoid different propagation times of the data transmitted via the two communication paths, the following method steps are recommended:

applying an exclusive-or logical operation to the clock signal and a constant binary value, in particular the value Zero, on the transmitter side,

transmission of the so encoded clock signal via the second communication path with at least one electrical transmitter, and

once more applying the logical exclusive-or operation to the encoded clock signal and the same constant binary value, in particular the value Zero, on the receiver side.

It has also proven to be advantageous if transmitters with a smaller coupling capacitance between their primary circuit and secondary circuit are employed, in particular transmitters with a coupling capacitance of less than 1 pF.

It is also advantageous to employ transmitters with a small damping and/or with safe electrical isolation of up to 720 volts.

In a particularly useful application, method according to the invention can be used to connect a power component for electrical drives, in particular for an intermediate circuit converter or inverter, with a comparatively high voltage potential to control electronics with a comparatively low voltage potential for bidirectional data exchange.

Additional advantages and details of the present invention are described in the following embodiments illustrated in the accompanying drawings. Elements with the same functionality are given the same reference numerals. It is shown in:

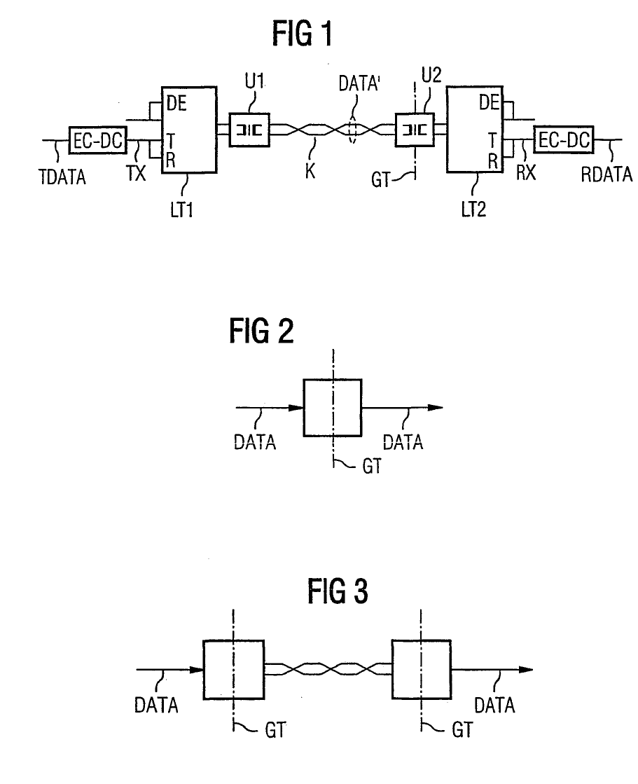

FIG. 1 a schematic circuit diagram of a serial data transmission in half duplex mode according to the invention,

FIG. 2 a schematic diagram of a data transmission with DC-isolation,

FIG. 3 a schematic diagram of data transmission with long lines and a double DC-isolation,

FIG. 4 a schematic circuit diagram of a serial data transmission with opto-couplers according to the state-of-the-art,

FIG. 5 a schematic circuit diagram of a serial data transmission with Ethernet technology according to the state-of-the-art,

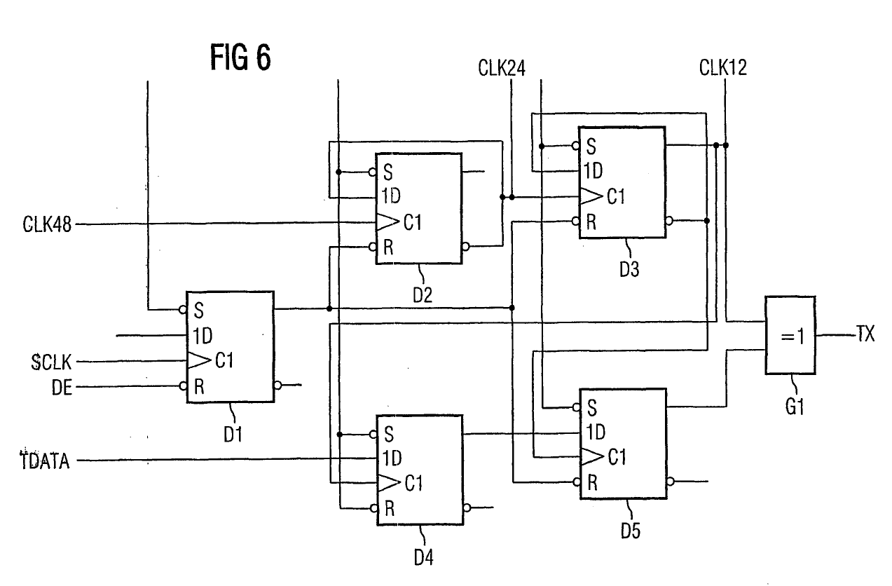

FIG. 6 a circuit arrangement for Manchester encoding,

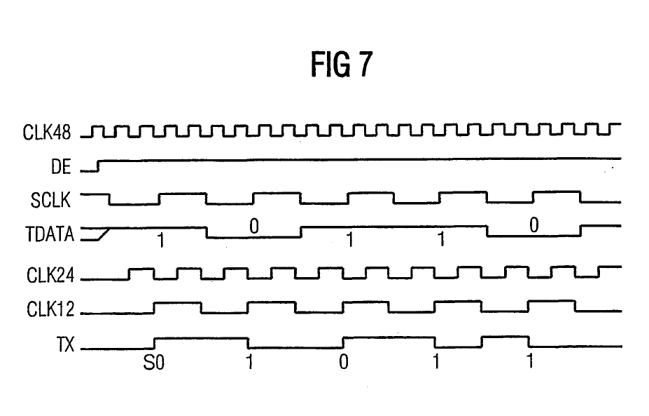

FIG. 7 a signal diagram of Manchester encoding,

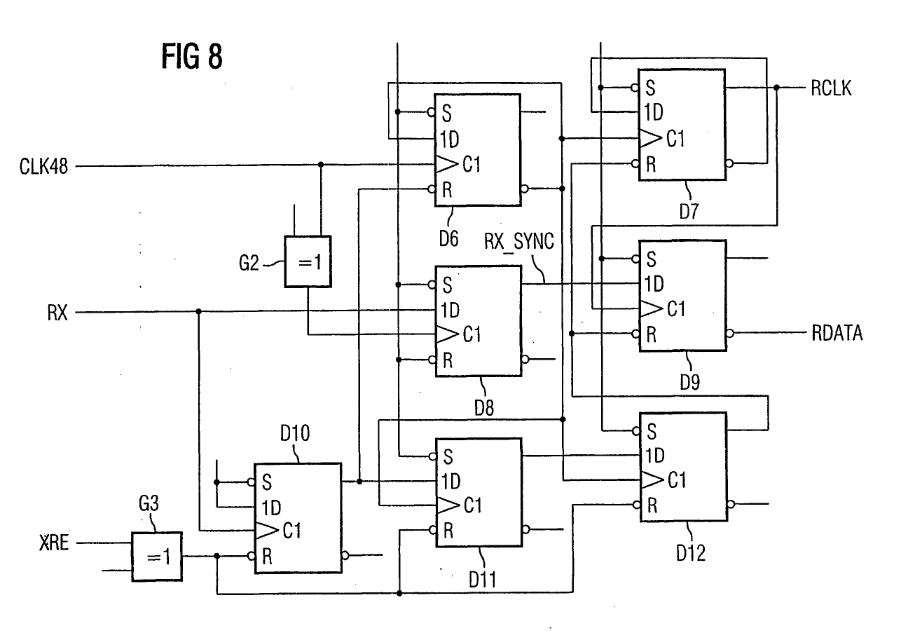

FIG. 8 a circuit arrangement for Manchester decoding,

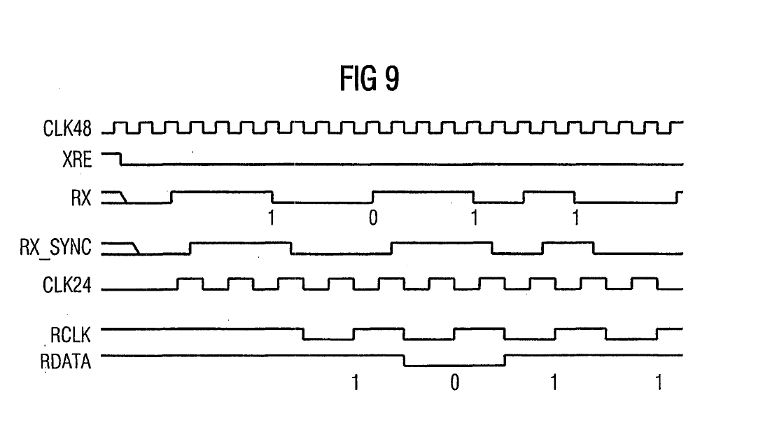

FIG. 9 a signal diagram of Manchester decoding, and

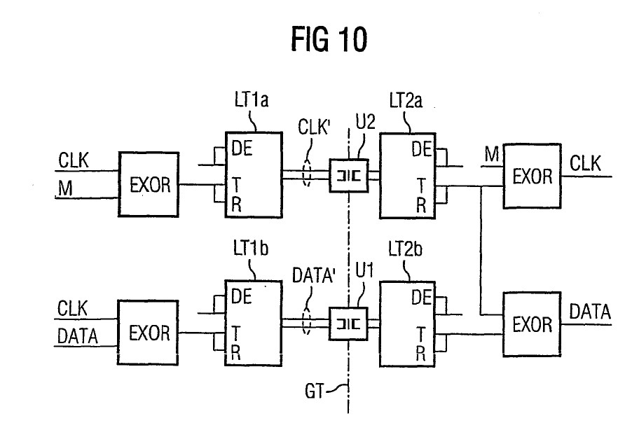

FIG. 10 a schematic circuit diagram of a serial transmission of synchronous data according to the invention.

According to the invention, the data stream is initially suitably processed and then transmitted via transmitters. These transmitters should have a very small coupling capacitance between primary and secondary side (typically<1 pF) so as to prevent problems caused by large temporal voltage changes du/dt. In addition, they should have a small damping to allow transmission of high data rates and should provide safe electrical isolation.

When using a transmitter, the signal is initially encoded without a DC component, which can be done, for example, by Manchester encoding.

To transmit signals over larger distances, inexpensive power drivers, such as a RS485 drivers, can be employed.

FIG. 1 shows a schematic circuit diagram of a serial data transmission in half duplex mode according to the invention, which takes into account the aforedescribed measures. The data DATA to be transmitted are encoded by an encoder/decoder EC_DC without a DC component, e.g. Manchester-encoded. The resulting encoded data DATA′ are applied to a power driver LT1 which transmits the data DATA′ via a communication path K to another power driver LT2. The power driver LT2 has an input T for data to be transmitted and an output R for data to be received.

Transmitters U1, U2 are connected between the corresponding power drivers LT1, LT2 and the communication path K, wherein at least one of the transmitters has to be able to provide a safe DC-isolation GT.

This practice according to the invention satisfies all criteria required above:

long lines and high data rates are feasible

a half duplex mode can be implemented inexpensively and can be upgraded to a full duplex mode by providing a second identical communication path K

a high immunity against interference is achieved at data transmission rates of approximately 12 Mbaud due to the small coupling capacitance of the transmitter

the transmitter enables safe electrical isolation

the first transmitter can be eliminated for short transmission distances (e.g. inside a device), so that only one transmitter is required for a safe isolation.

One possible application of the method according to the invention is the connection of a control assembly to a power section for implementing a decentralized drive concept for electrical drives. To save costs associated with opto-couplers, the arrangement uses power components with a control set unit that is at an intermediate negative circuit potential. This arrangement further requires a transmission path for data communication which should provide both DC-isolation as well as safe electrical isolation. For cost savings, the data interface should also include only a single transmission path (i.e., only half duplex data transmission).

The potentials are separated by transmitters which are used for DC-isolation between control electronics (PE-potential) and power section (negative intermediate circuit potential). The transmitters are selected so that they provide a safe isolation for a mains voltage of up to 3AC 720 V and are therefore suitable for all low voltage converters.

Because such a path is unable to transmit a DC component, the data are encoded prior to transmission to eliminate a DC component. A possible encoding form is Manchester encoding. To alternatives exist for processing slope changes:

a) 0=positive slope, 1=negative slope

b) 1=positive slope, 0=negative slope.

The first option was selected for the following example, because this option is preferred by semiconductor manufacturers for integrated solutions.

Since the transmission path is only used in half duplex mode, the start of each message is provided with a start bit S0, followed either by a data packet with a pre-defined length, or the length is transmitted with the beginning of the data packet. A “0” (=positive slope) was selected as start bit. This slope is also used to recover the clock signal and the data from the subsequent Manchester-encoded data. A corresponding encoder and decoder EC_DC with the associated timing diagrams is illustrated in FIGS. 6 to 9.

FIG. 6 shows a circuit arrangement for an encoder for Manchester encoding based on several logical switching gates. The circuit diagram can be easily understood by those skilled in the art and therefore does not need be described in detail. Used are flip-flop components D1 to D5 as well as a logical AND-gate G1.

FIG. 7 shows the associated signal diagram of the signals produced in the circuit arrangement according to FIG. 6, which are drawn on top of each other. These are the clock signals CLK48, CLK24, CLK12, which are obtained by dividing the clock frequency. A signal DE activates the encoder. SCLK represents the clock signal of the data stream TDATA to be encoded. The logical relationship between the corresponding signals will be recognized by those skilled in the art from the circuit arrangement of FIG. 6.

The essential effect of Manchester encoding can be recognized from the un-encoded signal TDATA and the encoded signal TX. For example, TDATA has a signal string ‘1011’, wherein the two consecutive logical values ‘One’ do not cause a change in the signal, i.e., TDATA is constant. Exactly this situation, however, can be responsible for undesirable DC components. Following successful Manchester encoding, the signal TX—following the aforedescribed start bit S0—automatically also has the signal string ‘1011’. However, the corresponding signal form of TX is different in that a change in slope occurs for two consecutive logical values ‘One’. A negative change in slope represents hereby the logical value ‘One’, whereas a positive change in slope represents the logical value ‘Zero’. Accordingly, this approach safely eliminates an undesirable DC component in the transmission.

FIG. 8 shows a circuit arrangement for decoding of Manchester-encoded signals based on several logical switching gates. This circuit is also known to those skilled in the art and needs not be explained in detail. Flip-flop components D6 to D12 as well as logical AND-gates G2 and G3 are employed.

FIG. 9 shows the associated signal diagram of the signals produced in the circuit arrangement according to FIG. 8, which are also drawn on top of each other. These are the clock signals CLK48 and CLK24 which are obtained by dividing the clock frequency. A signal XRE can be used to activate the decoding. RX represents the received Manchester-encoded data DATA′ of the data stream.

An internal synchronization signal RX_SYNC is obtained from these signals with the decoding arrangement depicted in FIG. 8. This synchronization signal together with the clock signal CLK24 aids in the recovery of the original data stream DATA. RCLK represents the recovered clock signal of the decoded data stream RDATA. The logical relationship between the corresponding signals will be recognized by those skilled in the art from the circuit arrangement of FIG. 6.

As seen by comparing the signals RX (Manchester-encoded data) and RDATA (decoded original data), RX supplies for the signal string ‘1011’ the signal change, as described above with reference to TX, even for a sequence of consecutive identical binary values, thereby eliminating a DC component, which cannot be processed by a transmitter. The decoded signal RDATA then carries again the original data of the data stream and hence corresponds to the signal TDATA or DATA.

Of course, various other encoding schemes can be used as long as a single transmission without a DC component is enabled.

In the embodiment depicted in FIG. 1 and FIGS. 6 to 9, the lines must not be interchanged. Otherwise, the complexity for signal recovery and the associated costs would be unacceptable.

According to another embodiment, synchronous data can be transmitted by applying a logical EXOR-operation to clock signal CLK and data DATA to suitably encode the signals so as to prevent the generation of DC components.

In this situation, the distance between transmitter and receiver is typically not large, thereby typically obviating the need for double DC-isolation. The embodiment depicted in FIG. 10 is based on this situation.

In this case, two data streams have to be transmitted, namely a data signal DATA and the clock signal CLK required for synchronous transmission, however not bidirectionally. As shown in the diagram of FIG. 10, two communication paths are provided, with each communication path being protected by a transmitter U1 and U2 with a safe DC-isolation GT. Each communication path has on both ends corresponding power drivers LT1a, LT1b and LT2a, LT2b (e.g., RS485 power drivers).

The DATA-signal has initially a DC component. In order to transmit the signal with a single transmitter, according to the invention a logical (exclusive or) EXOR-operation is first applied to the signal and the clock signal CLK, resulting in the encoded data signal DATA′. To prevent differences in propagation times, a logical EXOR-operation can be applied to the clock signal CLK and a constant binary value M, for example ‘Zero’, which results in the clock signal CLK′.

The logical operation applied to the data signal and clock signal therefore ensures that an encoded data signal DATA′ without a DC component can be transmitted via the transmitter U1. The clock signal itself is always free of a DC component.

Both signals DATA′ and CLK′ are then transmitted via the corresponding communication paths using the corresponding transmitter U1 and U2, and the original data stream DATA is recovered by repeating the EXOR-operation between both encoded signals DATA′ and CLK′. The original clock signal is recovered from CLK′ by repeating the EXOR-operation with the constant binary value M.

It will be understood that other logical operations, which enable a DC-component-free transmission of the data signal, can be applied to the data signal DATA and clock signal CLK. The aforedescribed EXOR-operation is particularly simple and effective in the context of the present invention.

A communication according to the invention can be used with the PROFIBUS standard by employing a configuration substantially similar to the configuration depicted in FIG. 4, wherein the opto-couplers O1 to O4 are replaced by transmitters connected after Manchester encoders EC_DC, as depicted in FIG. 1. This eliminates the limitation of the data rate to 12 Mbaud, which until now applied to the PROFIBUS.

1. Method for transmitting a high frequency binary data stream (DATA) via an, in particular bidirectional, DC-isolated (GT) communication path (K), with the following method steps:
encoding (EC_DC, D1 . . . D5, G1) the data stream (TDATA) without a DC component on the transmitter side by generating artificial signal changes through
transmission of binary values of the data stream as a specified sequence of signal changes (DATA′, TX, RX) via a communication path (K) with at least one electrical transmitter (U, U1, U2) and
recovery (EC_DC, D6 . . . D12, G2, G3) of the original binary values (RDATA) of the data stream by associating the corresponding binary values with the sequences of signal changes (TX, RX) received at the receiver side.

2. Method for transmitting a high frequency binary data stream (DATA) according to claim 1, wherein
to each binary value ‘Zero’ there is assigned the binary signal string ‘Zero’ followed by a ‘One’, and
to each binary value ‘One’ there is assigned the binary signal string ‘One’ followed by a Zero’.

3. Method for transmitting a high frequency binary data stream (DATA) according to claim 1, wherein
to each binary value ‘One’ there is assigned the binary signal string ‘Zero’ followed by a ‘One’, and
to each binary value ‘Zero’ there is assigned the binary signal string ‘One’ followed by a Zero’.

4. Method for transmitting a high frequency binary data stream (DATA) according to one of the claims 1 to 3, wherein a serial communication path (K) is employed for transmission.

5. Method for transmitting a high frequency binary data stream (DATA) according to claim 4, wherein a transmission occurs in half duplex mode, in that the beginning of each data stream on the transmitter side is provided with a characteristic value, in particular with a start bit (S0), for identification.

6. Method for transmitting a high frequency binary data stream (DATA) according to claim 5, wherein a corresponding characteristic value, in particular a start bit (S0), is used on the receiver side for the start of the data recovery (RDATA) of the data (TDATA) that were encoded without a DC component.

7. Method for synchronous transmission of a high frequency binary data stream with a data signal (DATA) and a clock signal (CLK) via an, in particular bidirectional, DC-isolated (GT) communication path (K), in particular according to claim 1, with the following method steps:
encoding the data signal by a logical operation of data signal (DATA) and a clock signal (CLK) on the transmitter side so as to produce an encoded data signal (DATA′) without a DC component,
transmitting the encoded data signal via a first communication path with at least one electrical transmitter (U1),
transmitting the clock signal (CLK) via a second communication path with at least one electrical transmitter (U2), and
decoding the encoded data signal (DATA′) on the receiver side by once more applying the logical operation to the encoded data signal (DATA′) and the clock signal (CLK) so as to recover the original data signal (DATA).

8. Method for synchronous transmission of a high frequency binary data stream according to claim 7, with the following additional method step:
encoding and decoding the clock signal (CLK) with the same logical operation with a constant binary value (M) and transmitting the encoded clock signal (CLK′).

9. Method for synchronous transmission of a high frequency binary data stream according to claim 7 or 8, with the following additional method steps:
encoding the data signal by applying a logical exclusive-or operation (EXOR) to the data signal (DATA) and clock signal (CLK) on the transmitter side,
decoding the encoded data signal (DATA′) on the receiver side by repeating the logical exclusive-or operation (EXOR) on the encoded data signal (DATA′) and clock signal (CLK).

10. Method for synchronous transmission of a high frequency binary data stream according to claim 9, with the following additional method steps:
exclusive-or logical operation (EXOR) of the clock signal (CLK) with a constant binary value (M), in particular with the value Zero, on the transmitter side,
transmission of the so encoded clock signal (CLK′) via the second communication path with at least one electrical transmitter (U2), and
repeating the logical exclusive-or operation (EXOR) on the encoded clock signal (CLK′) and the same constant binary value (M), in particular with the value Zero, on the receiver side.

11. Method for synchronous transmission of a high frequency binary data stream according to one of the preceding claims, wherein transmitters (U, U1, U2) with a smaller coupling capacitance between their primary circuit and secondary circuit are employed, in particular transmitters with a coupling capacitance of less than 1 pF.

12. Method for synchronous transmission of a high frequency binary data stream according to one of the preceding claims, wherein transmitters (U, U1, U2) with a small damping are employed.

13. Method for synchronous transmission of a high frequency binary data stream according to one of the preceding claims, wherein transmitters (U, U1, U2) with a safe electrical isolation of up to 720 V are employed.

14. Connection of a power component for electrical drives, in particular for an intermediate circuit converter or inverter, at a comparatively high voltage potential with a control electronics at a comparatively low voltage potential for bidirectional data exchange using the method according to the one of the preceding claims.
